(19) United States
(12) Patent Application Publication
(10) Pub. No.: US 2010/0253289 A1
(43) Pub. Date: Oct. 7, 2010

(54) METHOD AND SYSTEM FOR GRADUATED RESIDUAL BATTERY POWER UTILIZATION IN LONG-LIFE BATTERY POWERED DEVICES

(75) Inventors: Haim Amir, Ramat Hasharon (IL); Yoel Reichman, Raanana (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ESSENCE SECURITY INTERNATIONAL LTD., Herzliya (IL)

(21) Appl. No.: 12/419,340

(22) Filed: Apr. 7, 2009

(51) Int. Cl. H02J 7/00

(52) U.S. Cl. 320/135

(57) ABSTRACT

A method of graduated residual battery power utilization of a long-life battery in a battery-powered device, comprising the steps of: defining at least one residual power level for the battery;assigning progressively limited battery-powered device functionalities for each of the at least one power level; and enabling the battery-powered device to be operated according to the at least one residual power level and the respective limited functionalities so as to extend the life of the battery and to avoid a depleted battery condition.

### FIELD AND BACKGROUND OF THE INVENTION

The present invention relates to a method and system for long life battery operated devices and specifically for graduated residual battery power utilization for such devices.

In many battery-operated devices, such as but not limited to cellular telephones and security systems, both a smaller size and a mode of the operation of the device dictate that smaller, long life battery power be available virtually on a continuous basis. In order to ensure device operation, a user is usually given an indication of remaining battery power so that he may prepare to change or recharge batteries, if necessary. One common example is a cellular telephone, which typically displays remaining battery capacity. In some cases, cellular telephones sound an audible signal when battery power reaches a lower or residual levels.

In the specification and claims which follow hereinbelow, the term “residual” as used in conjunction with battery power and battery charge (i.e. “residual battery power”, “residual power”, “residual charge”, etc.) is intended to mean the amount of remaining battery power, or battery charge which is significantly below the optimal and/or the full battery charge. Typically a battery can still fulfill its intended purpose when having a residual charge. However, further loss of battery charge below the residual charge may affect battery performance to fulfill its intended purpose.

The term “power level”, as used in the specification and claims which follow hereinbelow, is intended to mean the remaining power capacity and/or remaining charge of a battery. Frequently, power level is expressed as the remaining charge (in volts) of a battery. The term “depleted battery”, as used in the specification and claims which follow hereinbelow, is intended to mean the condition when there is no effective or useful charge remaining in the battery and/or the battery cannot fulfill its intended purpose.

The term “long life”, as used in conjunction with a battery and its power level in the specification and claims which follow hereinbelow, is intended to mean an extended period of time, which may be highly variable, ranging typically from hours to years.

In the case of a cellular telephone, the user typically readily views the display and/or hears the signal so that user action (i.e. end a conversation or recharge and/or change batteries) may be performed. Most cellular telephones have batteries designed for active use—usually for a few hours—and for standby/passive operation—normally on the order of a number of hours up to a day or more. When the cellular telephone is in standby operation, and if is placed where the user cannot see/hear it, it is possible that battery power will be depleted, yielding the cellular telephone to be inoperable. Depending on the specific use of the cellular telephone, such a depleted battery condition can range from a mild inconvenience to a major problem.

One example of prior art where a user is given display and audible warnings is Japanese patent publication no JP2002191128, by Sadanori, whose disclosure is incorporated herein by reference. Sadanori describes an apparatus which warns a user of a battery-powered apparatus of a low residual amount of battery capacity without need for the user's paying attention thereto. If the residual amount of a battery is low, the apparatus warning by a beep gives a different warning beep from an ordinary warning beep when a warning beep is made during ordinary operation of the apparatus. An apparatus with a monitor warns the user of a low remaining battery level by changing the indication color of the monitor to an indication color different from a color in regular use.

Other battery-powered devices other than cellular telephones have very long-life batteries, allowing the device to be operated, typically most of the time in a standby mode, for months or even years. In the case of such devices, such as but not limited to: passive/intermittent communications devices; surveillance, security; and other similar systems and devices using battery power, a depleted battery condition is generally intolerable and should be avoided in every possible way. One way to avoid a depleted battery condition and to allow limited functionality with a residual battery power situation is to design mechanisms into a device and/or a battery to limit functionality, thereby limiting residual battery charge use.

U.S. Pat. No. 4,509,102, by Ayer, whose disclosure is incorporated herein by reference, is an example of prior art dealing with battery protection, specifically a current switch to protect the battery, inter alia, when the battery voltage drops below a predetermined value. US Patent Application no. 20070024241, by Bean, et al., whose disclosure is incorporated herein by reference, is another example of prior art dealing with battery protection and more specifically devices and systems to shut down a device when a preselected voltage threshold is reached. Both cited publications hereinabove do not expand upon user interface regarding conservation/protection of low and/or residual battery power.

Goris et al, in US Patent Application no. 20040257462, whose disclosure is incorporated herein by reference, describes an electronic camera having a battery, a battery charge-monitor circuit for monitoring battery charge, an embedded image-processing system, and a nonvolatile memory coupled to the embedded image-processing system for recording compressed images. The camera is capable of performing an initial compression and of performing advanced processing of images. The camera is capable of saving partially processed and/or intermediate images on nonvolatile memory, and suspending advanced processing, when the battery charge-monitor circuit detects that battery charge is less than a minimum or a reserve level. In an alternative embodiment, the camera is capable of reducing a clock rate at which advanced processing is performed to conserve battery charge.

There is therefore a need for a reliable, graduated residual battery power utilization method and system for intermittent and/or standby operations to avoid a totally depleted battery condition in long-life battery powered devices.

### SUMMARY OF THE INVENTION

The present invention relates to a method and system for battery operated devices and specifically for graduated low battery power utilization for such devices

According to the teachings of the present invention there is provided, a method of graduated residual battery power utilization of a long-life battery in a battery-powered device, comprising the steps of: defining at least one residual power level for the battery; assigning progressively limited battery-powered device functionalities for each of the at least one power level; and enabling the battery-powered device to be operated according to the at least one residual power level and the respective limited functionalities so as to extend the life of the battery and to avoid a depleted battery condition. Preferably, the limited functionalities serve to signal the need to replenish battery power. Most preferably, to signal the need to replenish battery power includes at least one chosen from the list including: an electromagnetic wavelength transmission to a remote device; a wired signal transmission to a remote device; a visible display on the battery-powered device; and an audible sound from the battery-powered device. Typically, replenishing battery power is chosen from the list including: replacing the battery; and recharging the battery.

Preferably, the remote device is chosen from the list including: a key fob; a magnetic card; an RFID device; a “smart card”; a remote relay device; a remote relay station; a transmitter, a receiver; a transceiver, a mobile phone, a PDA, a CPU, a vehicle remote control; a vehicle alarm remote control, and a portable computer. Most preferably residual power levels are determined when the battery has substantially a full charge. Typically, the at least one residual power level includes at least one chosen from the list including: LB, LBM, and LBC; wherein LB is higher than LBM and LBM is higher than LBC Most typically, the battery-powered device is a door lock and/or a safe lock.

Preferably, functionality of the door lock includes at least one chosen from the list including: a lock opening; a lock closing; a lock engaging; and a transmission of lock status. Most preferably, the functionality of the door lock is progressively limited according to progressively lower residual power levels. Typically, the battery includes at least one chosen from the list including: a rechargeable battery; a non-rechargeable battery; a combination rechargeable/non-rechargeable battery. Most typically, the battery further includes at least one chosen from the list including at least one conventional alkaline battery; at least one lithium ion battery; at least one lithium polymer battery; at least one NiCd battery; at least one NiMH battery; at least one SLA battery; and at least one silver zinc battery.

According to the teachings of the present invention there is further provided a long-life battery-powered device having graduated residual battery power utilization, comprising: a battery having at least one residual power level and having progressively limited battery-powered device functionalities definable for each of the at least one power level; and the battery-powered device operatable according to the at least one residual power level and the respective limited functionalities so as to extend the life of the battery and to avoid a depleted battery condition. Preferably, the limited functionalities are indicative as a signal to replenish battery power. Most preferably, the signal to replenish battery power includes at least one chosen from the list including: an electromagnetic wavelength transmission to a remote device; a wired signal transmission to a remote device; a visible display on the battery-powered device; and an audible sound from the battery-powered device. Typically, replenishment of battery power is chosen from the list including: a battery replacement and a battery recharging. Most typically, the remote device is chosen from the list including: a key fob; a magnetic card; an RFID device; a “smart card”; a remote relay device; a remote relay station; a transmitter: a receiver; a transceiver, a mobile phone, a PDA; a CPU; a vehicle remote control; a vehicle alarm remote control, and a portable computer.

Preferably, the at least one residual power level is determinable when the battery has a substantially full charge. Most preferably, the battery-powered device is a door lock and/or a safe lock. Typically, the battery includes at least one chosen from the list including: a rechargeable battery; a non-rechargeable battery; a combination rechargeable/non-rechargeable battery. Most typically, the battery further includes at least one chosen from the list including at least one conventional alkaline battery; at least one lithium ion battery; at least one lithium polymer battery; at least one NiCd battery; at least one NiMH battery; at least one SLA battery; and at least one silver zinc battery.

### BRIEF DESCRIPTION OF THE DRAWINGS

The invention is herein described, by way of example only, with reference to the accompanying drawings, wherein:

FIG. 1 is schematic plot of a battery used in a battery operated device showing a battery discharge function, in accordance with an embodiment of the present invention; and

FIG. 2 is a flowchart showing steps in a method of graduated residual battery power utilization of a long-life battery in a battery-powered device, in accordance with an embodiment of the current invention.

### DESCRIPTION OF PREFERRED EMBODIMENTS

The present invention relates to a method and system for battery operated devices and specifically for graduated low battery power utilization for such devices.

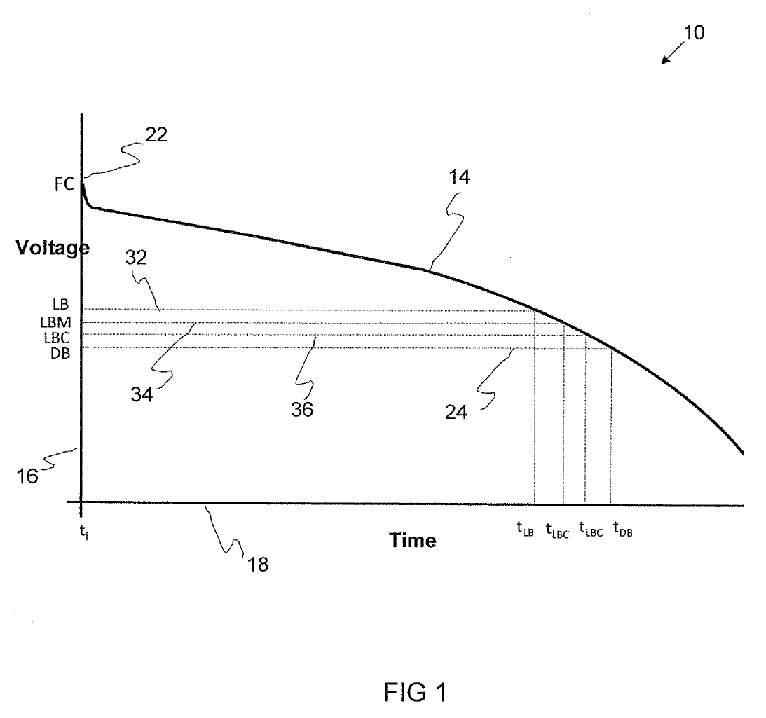

Reference is now made to FIG. 1, which is a schematic plot 10 of a battery used in a battery operated device showing a battery discharge function 14, in accordance with an embodiment of the present invention. Discharge function 14 is expressed as an ordinate 16 (“Voltage”) versus an axis 18 (“Time”). A full battery charge voltage 22, also indicated as FC, defines the substantially highest voltage value of function 14 expressed at an initial time tᵢ (see axis 18) value of substantially zero. A depleted battery charge voltage 24, also indicated as DB, is shown and has a corresponding time value expressed as t_{DB} on axis 18. As noted hereinabove, the battery cannot fulfill its intended purpose when the battery charge is depleted.

One or more residual voltage levels may be defined between FC and DB. The following are exemplary residual voltage levels, listed according to progressively lower residual voltage levels: LB, voltage 32; LBM, voltage 34; and LBC, voltage 36. Each of the residual voltage levels has an associated respective time value, as indicated on axis 18: t_{LB}, t_{LBM}, and t_{LBC}. Operation of the device is progressively limited at progressively lower residual voltage levels. The residual voltage levels are typically defined within the battery-powered device, most usually when a new or recharged battery initially powers the device. Definitions may be based upon fractions of FC voltage levels or upon predetermined voltage levels for a given battery or batteries. Alternatively or optionally, the residual voltage levels may be determined by a remotely located controller in communication with the device. Progressive limitation of functionality may be controlled by the device itself or it may be controlled by another device remote to the battery-powered device, as described in the example hereinbelow.

Function 14 can represent the exemplary discharge function a long life battery, such as but not limited to one or more of the following batteries: conventional alkaline batteries; conventional lithium batteries; lithium polymer batteries, rechargeable batteries, hybrid rechargeable-non-rechargeable batteries, and similar batteries (which typically have the FC value ranging from approximately 4.5V to 3.0V). Examples of similar batteries may be: Nickel Cadmium (NiCd); Nickel Metal Hydride (NiMH); Sealed Lead Acid (SLA); and silver zinc. The DB value can range from approximately 1.9 to approximately 0.9 V, depending on the battery type. The elapsed time for function 14 from FC to DB, meaning the elapsed time from tᵢ to t_{DB} is highly dependent inter alia, upon the operation of the device powered by the battery or batteries; however it can range from days to as much as years. In addition, function 14 is dependent on device ambient temperature, which for the vast majority of most battery operated devices can range from 0 to 50 degrees C., but most typically ranges more closely around typical room temperature.

One example of a battery operated device having a battery or batteries exhibiting function 14 is a semi-automatically electrically controlled door or window lock, which does not have a mechanical key for typical operation. The door lock can normally be operated completely mechanically from within a house (i.e. operating the lock from within the space secured by the door lock) so that a depleted battery situation has no effect on door lock operation from within the house. However door lock functioning is typically only electrical/electronic when operated from outside of the house. Keypad commands from a keypad or similar device on the outside of the door lock and/or RF or other wireless or IR (referred collectively to in the specification and claims which follow as “electromagnetic wavelength transmission”) command signals from a remotely operated device serve to activate exemplary functions such as but not limited to: opening, closing, and locking, the door lock. (Exemplary remote devices include but are not limited to: a key fob; a magnetic and/or “smart card”; an RFID device: a remote relay device; a remotely located control station; a mobile telephone; a PDA; a CPU; a vehicle remote control; a vehicle alarm remote control, a portable computer, and/or other receiver and/or transmitter. Alternatively or optionally, the command signals from the remotely operated device may be transferred by wired connection to the operated device.

In one embodiment of the current invention, the battery-powered device has wireless communication with a remotely located control station. The remotely located control station can be alerted by wireless means, for example, regarding battery status, including the battery reaching various residual battery levels. When a residual battery level is reached and when one or more users—including people with no ability or knowledge of how to change the device battery—operate the door in the residual battery level, the control station is cognizant of the situation and, for example, a technician may be sent to change the battery, to help avoid a depleted battery condition. However, due to overall logistics considerations and/or the cost considerations it may not possible and/or practical to immediately send a technician to change the battery. As a result, a solution such as residual power levels may be useful.

Using the exemplary residual voltage levels defined above, functionalities of the door lock may have definitions of battery residual power levels respectively progressively limited as described hereinbelow.

LB: When the battery voltage reaches this level, the door lock sends a notification to the control station and the door lock is limited to a fixed number of operations and for a fixed time—whichever occurs first—before functionality is stopped. One example is 50 operations during a 30-day period. (It is understood/assumed that the door lock and/or the control station have counters, as known in the art, which track functionality and time periods.) In this case, a door lock operation could be defined as: a lock opening; a lock closing/engaging; status (i.e. “lock open”/“lock closed”) transmission, etc.

LBM: When the battery voltage value reaches this level, the door lock is in a more serious energy-savings mode. When LBM voltage is reached the door lock may send a notification to the control station of such. In order for the user to open the door, he now has to additionally push a button (or similar user interface on the door lock) to allow a time window to open, for example 30 seconds, during which the user can electronically command to opening the door lock, as described hereinabove. If the command is not issued within the time window, the user must start the procedure again to open the door. The number of attempts is limited and a count is maintained. An example of the limited number of attempts is 20 attempts.

LBC: When the battery voltage value reaches this level, the door lock can be opened only when the user contacts the control center (for example by cellular telephone), following which the user must perform a function on the door lock—such as pushing a button or a similar user interface on the lock—to allow the control center to give a command to the door lock to open. This mode of operation is limited to a fixed number of operations and the number and decrement of operations may be coordinated with the control center.

DB: As noted hereinabove, when this battery level is reached, there is no battery functionality and the door lock is inoperable until a new battery is provided.

In addition to limiting the functionality and extending residual battery power, the limiting of functionality itself serves in embodiments of the current invention as a signal to a user/controller to replenish battery power, such as by replacing and/or recharging batteries. Furthermore, the door lock can show a visible signal (such as but not limited to a blinking LED) and/or sound an audible sound to further signal the user when one or more residual power levels have been reached to further signal the need to replenish battery power.

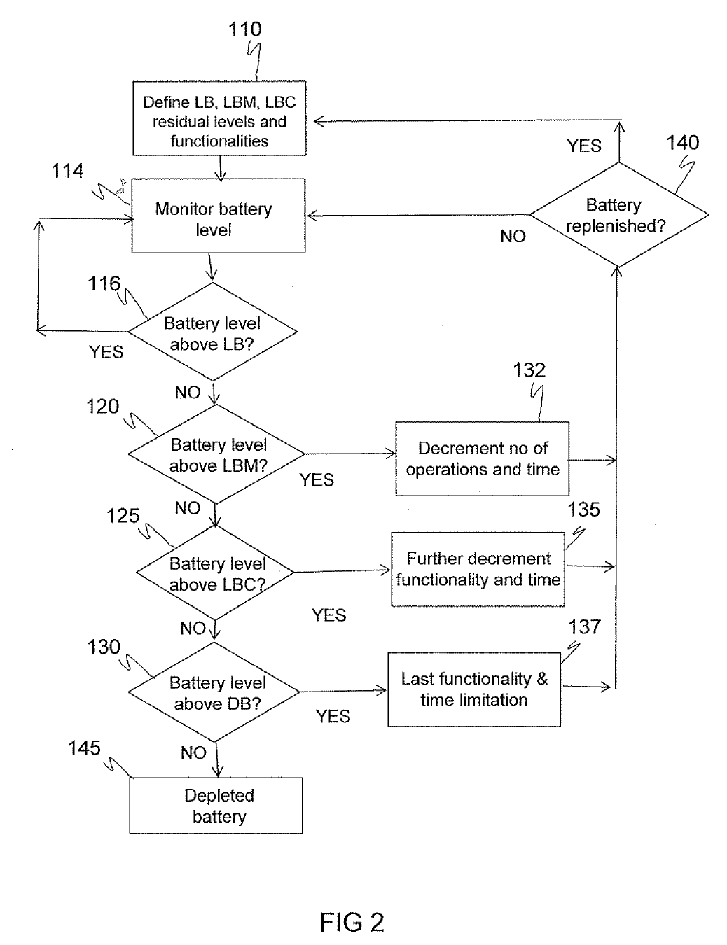

Reference is now made to FIG. 2, which is a flowchart showing steps of graduated residual battery power utilization of a long-life battery in a battery-powered device, in accordance with an embodiment of the current invention. FIG. 2 includes notations such as LB, LBM, and LBC, DB which are identical in operation and functionality to those shown in FIG. 1 and as described hereinabove.

“Define LB, LBM, LBC residual levels and functionality” 110 is the first step, wherein the residual power levels, namely LB, LBM, and LBC are defined. Step 110 occurs typically with a full or near-full battery, meaning typically at voltage level approximately equal to FC and may involve battery-powered device self-checks and residual power level and functionality determination. Alternatively or optionally, communication with the control center may take place for residual power levels and functionality to be determined or previously-programmed values of voltage and/or time can likewise be used for functionality to be determined.

“Monitor battery level” 114 follows step 110. The battery level is monitored, either on a continuous or a relatively frequently discrete basis and residual power level checks are performed as described hereinbelow. Steps 116 “Battery level above LB?”, 120 “Battery level above LBM”, and 125 “Battery level above LBC”, and 130 “Battery level above DB” can sequentially follow. If the battery level is above LB, then flow is reverted to step 114 and the battery continues to be monitored.

If the battery level is not above LB, but it is above LBM (step 120, YES) then flow is transferred to step 132 “Decrement no of operations and time”, wherein battery and device functionality and time are limited as described hereinabove for FIG. 1. If the battery level is not above LBM, but it is above LBC, (step 125, YES) then flow is transferred to step 132 “Further decrement functionality and time”, wherein battery and device functionality and time are again limited, as described hereinabove for FIG. 1. If the battery level is not above LBM, but it is above LBC, (step 130, YES) then flow is transferred to step 137 “Last functionality and time limitation”, wherein battery and device functionality and time are limited as described hereinabove for FIG. 1.

Step 140 “Battery replenished” follows steps 132, 135, and 137. As noted hereinabove in the description of FIG. 1, respective residual power limitations serve to signal the need for battery power replenishment such as a battery replacement/recharge, which can take place when the battery reaches subsequent residual power levels. If the battery is not replenished (i.e. NO), then flow reverts to step 114 “Monitor battery”. If the battery is replenished (i.e. YES) then flow is reverted to step 110.

Finally, if following step 130 “Battery level above DB” the battery is NOT above DB level; all device functionality is stopped and flow is transferred to step 145 “Depleted battery”. The depleted battery description is as described hereinabove for FIG. 1. In virtually all cases, it is desirable to avoid a depleted battery condition, as previously noted.

It should be noted that whereas the example described hereinabove for the method for battery operated devices and specifically for graduated low battery power utilization has been for an electronic door lock device; embodiments of the current invention are equally applicable to other long-life battery powered devices such as but not limited to: a door lock and a safe lock.

It will be appreciated that the above descriptions are intended only to serve as examples, and that many other embodiments are possible within the scope of the present invention as defined in the appended claims.

What is claimed is:

1. A method of graduated residual battery power utilization of a long-life battery in a battery-powered device, comprising the steps of:
a. defining at least one residual power level for the battery;
b. assigning progressively limited battery-powered device functionalities for each of the at least one power level; and
c. enabling the battery-powered device to be operated according to the at least one residual power level and the respective limited functionalities
so as to extend the life of the battery and to avoid a depleted battery condition.

2. The method of claim 1, wherein the limited functionalities serve to signal the need to replenish battery power.

3. The method of claim 2, wherein to signal the need to replenish battery power includes at least one chosen from the list including: an electromagnetic wavelength transmission to a remote device; a wired signal transmission to a remote device; a visible display on the battery-powered device; and an audible sound from the battery-powered device.

4. The method of claim 2, wherein replenishing battery power is chosen from the list including: replacing the battery; and recharging the battery.

5. The method of claim 2, wherein the remote device is chosen from the list including: a key fob; a magnetic card; an RFID device; a “smart card”; a remote relay device; a remote relay station; a transmitter, a receiver; a transceiver, a mobile phone, a PDA, a CPU, a vehicle remote control, a vehicle alarm remote control, and a portable computer.

6. The method of claim 2, wherein residual power levels are determined when the battery has substantially a full charge.

7. The method of claim 6, wherein the at least one residual power level includes at least one chosen from the list including: LB, LBM, and LBC; wherein LB is higher than LBM and LBM is higher than LBC.

8. The method of claim 6, wherein the battery-powered device is a door lock.

9. The method of claim 6, wherein the battery-powered device is a safe lock.

10. The method of claim 8, wherein functionality of the door lock includes at least one chosen from the list including: a lock opening; a lock closing; a lock engaging; and a transmission of lock status.

11. The method of claim 10, wherein the functionality of the door lock is progressively limited according to progressively lower residual power levels.

12. The method of claim 1, wherein the battery includes at least one chosen from the list including: a rechargeable battery; a non-rechargeable battery; a combination rechargeable/non-rechargeable battery.

13. The method of claim 12, wherein the battery further includes at least one chosen from the list including at least one conventional alkaline battery; at least one lithium ion battery; at least one lithium polymer battery; at least one NiCd battery; at least one NiMH battery; at least one SLA battery; and at least one silver zinc battery.

14. A long-life battery-powered device having graduated residual battery power utilization, comprising:
a. a battery having at least one residual power level and having progressively limited battery-powered device functionalities definable for each of the at least one power level; and
b. the battery-powered device operatable according to the at least one residual power level and the respective limited functionalities
so as to extend the life of the battery and to avoid a depleted battery condition.

15. The device of claim 14, wherein the limited functionalities are indicative as a signal to replenish battery power.

16. The device of claim 15, wherein the signal to replenish battery power includes at least one chosen from the list including: an electromagnetic wavelength transmission to a remote device; a wired signal transmission to a remote device; a visible display on the battery-powered device; and an audible sound from the battery-powered device.

17. The device of claim 15, wherein replenishment of battery power is chosen from the list including: a battery replacement and a battery recharging.

18. The device of claim 15, wherein the remote device is chosen from the list including: a key fob; a magnetic card; an RFID device; a “smart card”; a remote relay device; a remote relay station; a transmitter: a receiver; a transceiver, a mobile phone, a PDA; a CPU; a vehicle remote control; a vehicle alarm remote control, and a portable computer.

19. The device of claim 15, wherein the at least one residual power level is determinable when the battery has a substantially full charge.

20. The device of claim 14 wherein the battery-powered device is a door lock.

21. The device of claim 14, wherein the battery-powered device is a safe lock.

22. The device of claim 14, wherein the battery includes at least one chosen from the list including: a rechargeable battery; a non-rechargeable battery; a combination rechargeable/non-rechargeable battery.

23. The device of claim 22, wherein the battery further includes at least one chosen from the list including at least one conventional alkaline battery; at least one lithium ion battery; at least one lithium polymer battery; at least one NiCd battery; at least one NiMH battery; at least one SLA battery; and at least one silver zinc battery.
